(19) United States
(12) Patent Application Publication
(10) Pub. No.: US 2009/0311359 A1
(43) Pub. Date: Dec. 17, 2009

(54) Hot Runner Nozzle

(76) Inventor: Herbert Gunther, Allendorf (DE)

Correspondence Address: CLARK & BRODY, 1090 VERMONT AVENUE, NW, SUITE 250, WASHINGTON, DC, 20005, US

(21) Appl. No.: 12/226,474

(22) PCT Filed: Mar. 30, 2007
(86) PCT No.: PCT/EP2007/002875

§ 371 Date: Mar. 6, 2009

(30) Foreign Application Priority Data
Apr. 21, 2006 (DE) 20 2006 006 671.3

(51) Int. Cl. B29C 45/78

(52) U.S. Cl. 425/170

(57) ABSTRACT

The invention relates to an injection mold's hot runner nozzle (10) of which the injection material feeding pipe (20) contains at least one flow duct (30) for a flowable/fluid material. The hot runner nozzle (10) also comprises a heater (40) heating the fluid injection material and a temperature sensor (50) mounted in fixed manner in the region of the heater (40) on said injection material pipe. By means of this configuration and the simple design of the hot runner nozzle, control and measurement of the temperature of the hot runner nozzle (10) are achieved in durable, reliable and economical manner in particular in the end zone of said pipe (20).

The present invention relates to a hot runner nozzle for an injection mold defined in the preamble of claim 1.

Hot runner nozzles are used in injection molds to feed a flowable, i.e. fluid pressurized material such as a plastic melt at a predetermined temperature to a separable mold insert. Typically such nozzles comprise an injection material feeding pipe fitted with a flow duct terminating in a nozzle orifice. Said nozzle orifice subtends at its end a nozzle discharge aperture issuing through a sprue aperture into the mold insert (mold nest). To preclude the fluid injection material from prematurely cooling inside the injection material feeding pipe, a heater is used to assure the best possible uniform temperature distribution as far as into the nozzle orifice. A thermal spacer (insulation) between the hot nozzle and the cold mold precludes nozzle freezing and heating the mold respectively the mold insert.

High requirements are set on the temperature control in a hot runner nozzle because the plastics to be processed frequently offer only a very narrow processing window and react very strongly to temperature fluctuations. Illustratively a temperature change of only a few degrees already may entail injection defects and wastes. Accordingly accurate temperature control is required for a well-running and automated hot runner mold. It is important therefore that with respect to multiple molds, for instance having 24, 32, or 64 cavities, the setpoint temperature shall be the same for all mold nests. As a result, the setpoint temperature must very accurately coincide with the actual temperature within the nozzle.

Typically temperature sensors are used to monitor and control the temperature. As illustratively disclosed in the EP 0 927 617 A1 or DE 201 00 840 U1 documents, said temperature sensors are inserted as separate elements in grooves respectively boreholes fitted in the nozzle body or in the heater. However problems are incurred in that already a minor shift in position of a temperature sensor may entail significant measurement errors adverse affecting temperature reproducibility.

The objective of the present invention is to avert those and other drawbacks of the state of the art and to create a hot runner nozzle of which the temperature can be both measured and controlled accurately. Furthermore the temperature is to be accurately predeterminable, and be durably reliable, especially in the terminal zone of the injection material feeding pipe. The nozzle as a whole shall be of simple design and of economical manufacture.

The main features of the present invention are stated in claim 1. Embodiment modes are defined in claims 2 through 11.

As regards an injection-mold hot runner nozzle fitted with an injection material feeding pipe in which is subtended at least one flow duct for a fluid injection material, further comprising a heater for said material and a temperature sensor configured in the region of said heater, the present invention provides that said sensor be affixed to said pipe. In this manner the nozzle temperature, and hence the temperature of said fluid material within the flow duct always shall be measured at the same site. In this manner the entire hot runner system can be accurately controlled, and the temperature can be accurately kept at the same value even in a mold with a plurality of nozzles.

It is important that the temperature sensor shall be affixed in the terminal zone of the injection material feeding pipe. In this manner the temperature is measured in the zone of the nozzle orifice, respectively the nozzle tip, namely where the largest heat losses may arise.

In an advantageous design of the present invention, the temperature sensor is fitted with a sleeve affixed to said pipe. In this manner the temperature sensor is reliably fixed in position in durable manner. Also the sensor end no longer is able to move relative to said pipe or to the heater, the process control being commensurately more reliable.

Preferably the sleeve is pressed, soldered or bonded on the temperature sensor. Said sleeve advantageously also is made of a thermally well conducting substance to assure unfailingly optimal results.

In another important embodiment mode of the present invention, said sleeve may be a crimping sleeve and is welded, soldered or bonded to said pipe. The nozzle design is simplified thereby, and its manufacture more economical.

The heater appropriately receives the temperature sensor of which the measuring site is externally accessible. This feature offers the advantage that the temperature sensor can be affixed rapidly and conveniently to the injection material feeding pipe. In a pertinent additional feature, the temperature sensor's measurement site is situated in a recess of the heater, the temperature sensor always being reliably fixed in place in the recess zone to the said pipe's outer circumference.

Further features, details and advantages of the present invention are contained in the claims and in the description below of illustratively embodiments shown in the appended drawings.

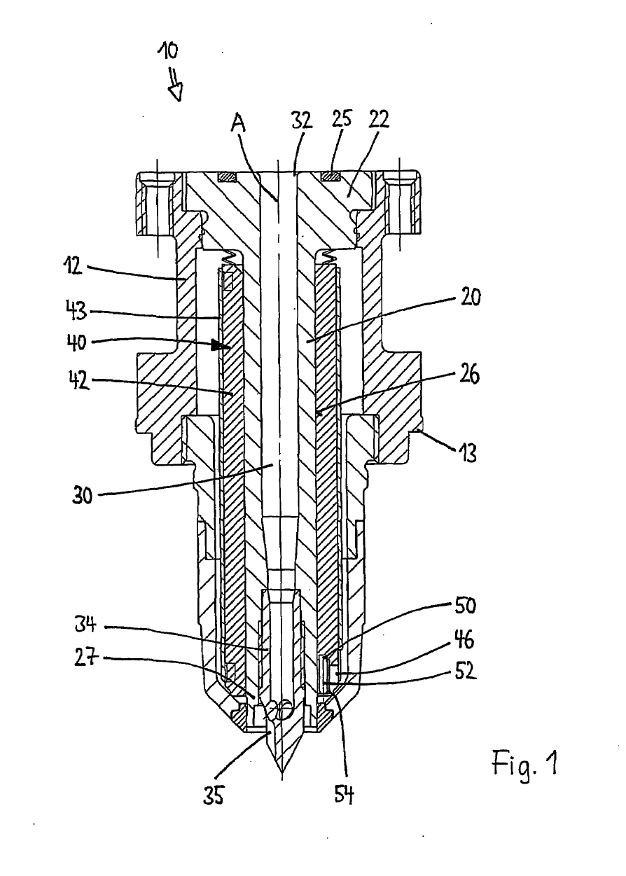

FIG. 1 is a sectional view of a hot runner nozzle and

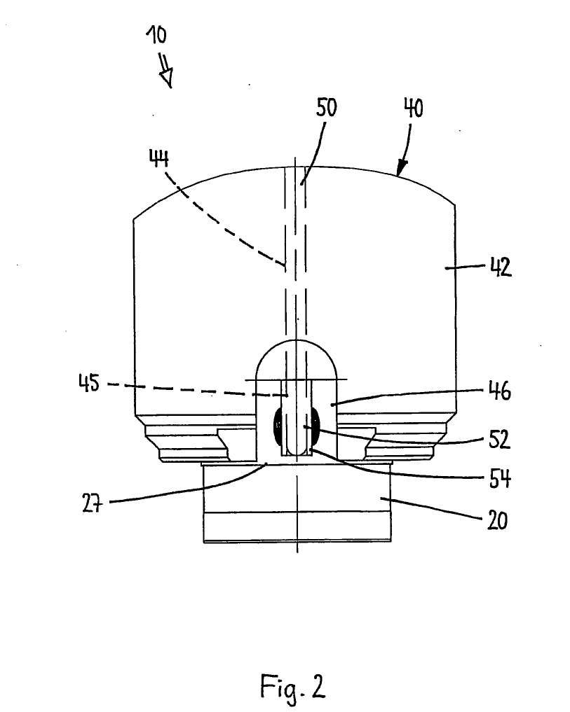

FIG. 2 is an enlarged partial side view of the hot runner nozzle of FIG. 1.

The hot runner nozzle 10 of FIG. 1 is used in injection molds. It comprises an injection material feeding pipe 20 fitted at its top end with a flange-like connection head 22. Said head is detachably seated in a housing 12 that can be fixed in position from underneath by an omitted manifold plate. A radial step 13 centers the housing 12 and thereby also the nozzle 10 within the mold.

A flow duct 30 for a plastic melt is centrally configured in the injection material feeding pipe 20 which runs in the axial direction A. Said duct 30 preferably is a borehole and is fitted in the connection head 22 with an injection material feed aperture 32 while issuing at its lower end into a nozzle orifice 34 illustratively in the form of a nozzle tip. Said nozzle tip comprises an injection material discharge aperture 35 to allow the flowable plastic melt to enter an omitted mold nest. The nozzle orifice 34 preferably is made of a thermally highly conducting substance and is terminally inserted into the injection material feeding pipe 20, preferably being screwed into it. However, depending on the application, said pipe 20 also may be supported in axially displaceable manner or be integral with the pipe 20 while its operation shall be the same.

A sealing ring 25 is configured in the connection head 22 of the injection material feeding piper 20 concentrically with the injection material feed aperture 32 to seal the hot runner nozzle 10 relative to the manifold plate. Moreover an omitted, additional annular centering protrusion may be used to facilitate said nozzle's assembly into the mold.

A heater 40 is mounted on the external periphery 26 of the injection material feeding pipe 20. Said heater 40 may be in the form of a thermally well conducting bush 42 made of a substance such as copper or brass and running over almost the full axial length of the injection material feeding pipe 20. Coaxially with the flow duct 30, an omitted electrical heating coil is configured in the wall (not shown in further detail) of the bush 42, the omitted coil terminals running laterally out of the housing 12. The heater 40 as a whole is enclosed by a sheath 43.

A temperature sensor 50 runs through the heater 40 as far as the end zone 27 of the injection material feeding pipe 20 to detect the temperature generated by the heater 40. For that purpose the bush 42 of the heater 40 is fitted with a borehole 44 receiving the detector 50 and preferably running parallel to the flow duct 30 (FIG. 2). The lower end 45 of the borehole 44 terminates in a U-shaped recess 46 subtended at the edge of the wall of the bush 42 as well as into the sheath 43.

FIG. 2 shows that the substantially rod-like temperature sensor 50 comprises an end 52 constituting a measuring tip by means of which it ends in the recess 46 of the bush 42 and is affixed there on the outer periphery 26 of the injection material feeding pipe 20. For that purpose the externally accessible free end 52 of the detector 50 is fitted with a thermally well conducting sleeve 54, for instance a crimp sleeve firmly compressed on the detector 50. The crimp sleeve 54 is affixed within the recess 46 to the external periphery 26 of the injection material feeding pipe 20, preferably by laser welding. The required access is through the recess 46.

As a result, the positions of the crimp sleeve 54 and hence that of the temperature sensor 50 are accurately set relative to the injection material feeding pipe 20 and the temperature always is measured at one and the same point. The temperature sensor 50 is kept fixed in position and this feature precludes temperature measurement error. Indeed the temperature at the outer end of said pipe 20 and hence in the vicinity of the nozzle orifice 34 can be measured accurately and precisely, and consequently all the nozzle 10 can be can be controlled rigorously.

The omitted terminals of the temperature sensor 50 pass jointly with the terminals of this heater 40 sideways out of the housing 12.

The present invention is not restricted to the above discussed embodiment modes, rather it may be modified in many was. Illustratively the heater 40 may be integrated into the injection material feeding pipe 20 or it may be in the form of flat heater. The element used in the heater 40 alternatively may be a tube system passing a heating medium such as water or oil where for instance electrical heating should be undesirable or unavailable on other grounds. The present invention also is immediately applicable to cold runner nozzles.

It is clear from the above that an injection mold hot runner nozzle 10 comprises a material injection feeding pipe 20 subtending at least one flow duct 30 for such an injection material. A heater 40 for the fluid injection material is affixed to the said pipe 20 and a temperature sensor 50 is configured in the region of said heater. This temperature sensor 50 is affixed to the external periphery 26 of the pipe 20, in particular by its end 52 constituting a measuring tip respectively a measurement point. Preferably the measurement point of the temperature sensor 50 is situated in the injection molding feeding pipe's end zone 27 and in the region of a recess 40 constituted in the heater 40. The temperature sensor 50 is terminally fitted with a sleeve 54, especially by compression, to improve position fixation and heat transfer, said sleeve being affixed to said pipe 20. The sleeve 54 is thermally well conducting and in particular is a crimp sleeve.

All features and advantages explicit and implicit in the claims, specification and drawing, including design details, spatial configurations and procedural steps, may be inventive per se or in arbitrary combinations.

### LIST OF SYMBOLS

A axial direction
10 needle valve nozzle aperture
12 housing
13 step
20 injection material feeding pipe
22 connection head
25 sealing ring
26 outer periphery/circumference
27 end zone
30 flow duct
32 injection material feed aperture
34 nozzle orifice
35 injection material discharge aperture
40 heater
42 bush
43 sheath
44 borehole
45 end
46 recess
50 temperature sensor
52 end/measuring tip
54 crimp sleeve

1. A hot runner nozzle (10) for an injection mold, comprising an injection material feeding pipe (20) containing at least one flow duct (30) for a flowable/fluid injection material, further a heater (40) for the fluid injection material, and a temperature sensor (50) configured in the region of the heater (40) characterized in that the temperature sensor (50) is affixed to the injection material feeding pipe (20).

2. Hot runner nozzle as claimed in claim 1, characterized in that the temperature sensor (50) is situated in the end zone (27) of the injection material feeding pipe (20).

3. Hot runner nozzle as claimed in claim 1, characterized in that the temperature sensor (50) is terminally fitted with a sleeve (54) affixed to the injection material feeding pipe (20).

4. Hot nozzle runner as claimed in claim 3, characterized in that the sleeve (54) is pressed on, soldered or bonded to the temperature sensor (50).

5. Hot runner nozzle as claimed in claim 3, characterized in that the sleeve (54) is thermally well conducting.

6. Hot runner nozzle as claimed in claim 3, characterized in that the sleeve (54) is a crimp sleeve.

7. Hot runner nozzle as claimed in claim 3, characterized in that the sleeve (54) is welded, soldered or bonded to the injection material feeding pipe (20).

8. Hot runner nozzle as claimed in claim 1, characterized in that the temperature sensor (50) is seated in the heater (40).

9. Hot runner nozzle as claimed in claim 8, characterized in that the measurement point of the temperature sensor (50) is externally accessible.

10. Hot runner nozzle as claimed in claim 8, characterized in that the measurement point of the temperature sensor (50) is situated within a recess (46) in the heater (40).

11. Hot runner nozzle as claimed in claim 10, characterized in that the temperature sensor (50) is affixed in place within the recess (46) on the external periphery (26) of the injection material feeding pipe (20).
